(19) United States
(12) Patent Application Publication
(10) Pub. No.: US 2020/0164844 A1
(43) Pub. Date: May 28, 2020

(54) VEHICLE, METHOD OF PROVIDING INFORMATION ABOUT ROAD SURFACE STATE FOR VEHICLE, AND METHOD FOR PROVIDING SAFE DRIVING FOR VEHICLE

(71) Applicants: HYUNDAI MOTOR COMPANY, Seoul (KR); KIA MOTORS CORPORATION, Seoul (KR)

(72) Inventor: Sung Chil JUNG, Hwaseong-si (KR)

(73) Assignees: HYUNDAI MOTOR COMPANY, Seoul (KR); KIA MOTORS CORPORATION, Seoul (KR)

(21) Appl. No.: 16/509,691

(22) Filed: Jul. 12, 2019

(30) Foreign Application Priority Data
Nov. 26, 2018 (KR) 10-2018-0147311

(51) Int. Cl. B60T 8/1755; B60W 30/02; B60W 40/068; G08G 1/0965; B60W 50/14

(52) U.S. Cl. CPC B60T 8/1755; B60W 30/02; B60W 40/068; G01C 21/34; B60W 50/14; B60W 2550/148; B60W 2550/408; G08G 1/0965

(57) ABSTRACT

The present disclosure relates to a vehicle that detects a road surface state during operation of a vehicle stability system due to rapid braking while the vehicle is traveling, generates information about the detected road surface state, and shares the generated information with at least one external object, and a method of providing information about the road surface state for the vehicle. In addition, the present disclosure relates to a vehicle that receives information about the state of a road surface on which at least one external vehicle is traveling from the external vehicle during traveling, determines whether the state of the road surface on which the vehicle is currently traveling corresponds to a dangerous state or a safe state based on the received information about the road surface state, and informs a driver of the determination result, and a method of providing safe driving for the vehicle.

### CROSS-REFERENCE TO RELATED APPLICATION

This application claims the benefit of Korean Patent Application No. 10-2018-0147311, filed on Nov. 26, 2018, the entire contents of which is hereby incorporated by reference.

### FIELD

The present disclosure relates to a vehicle that can collect information about the road surface state.

### BACKGROUND

The statements in this section merely provide background information related to the present disclosure and may not constitute prior art.

In general, a safety control system of a vehicle to assist the driving stability of the vehicle serves to inhibit the vehicle from becoming imbalanced because the vehicle deviates outwards from a desired driving course or because the turning radius of the vehicle decreases sharply due to an unintended increase in the turning speed thereof.

In particular, while the vehicle travels, the state of the road surface is one of the most important factors that influence the safe driving of the vehicle, and the coefficient of friction between the wheels and the road surface is changed depending on the road surface state.

Compared to a road surface having a relatively large coefficient of friction, severe slippage of the wheels occurs on a road surface having a relatively small coefficient of friction. Thus, even when a small amount of braking force is applied to the wheels, the wheels easily become locked up.

Therefore, the vehicle safety control method is varied depending on whether the coefficient of friction of the road surface is large or small.

Considering the influence of the road surface state on the driving stability of the vehicle, a sensor module for detecting the road surface state is installed in the vehicle.

However, if the road surface state is locally detected only by the sensor module provided in the vehicle, for example, in the case in which there is a large difference between the road surface state inside a tunnel and the road surface state outside the tunnel, the vehicle may undergo a sudden change in the road surface state when entering or exiting the tunnel, and thus the safety control system of the vehicle may not effectively respond to the sudden change in the road surface state, leading to deterioration in reliability of safety control.

In addition, if the sensor module that measures the coefficient of friction of the vehicle breaks down, because there is no way to correct the coefficient of friction while the vehicle travels, this may have a seriously negative influence on safety control for the vehicle.

### SUMMARY

Accordingly, the present disclosure is directed to a vehicle, a method of providing information about a road surface state for the vehicle, and a method of providing safe driving for the vehicle.

The present disclosure provides a vehicle that detects a road surface state during the operation of a vehicle stability system due to rapid braking while the vehicle is traveling, generates information about the detected road surface state, and shares the generated information with at least one external object, and a method of providing information about a road surface state for the vehicle.

The present disclosure also provides a vehicle that receives information about the state of a road surface on which at least one external vehicle is traveling from the external vehicle during traveling, determines whether the state of the road surface on which the vehicle is currently traveling corresponds to a dangerous state or a safe state based on the received information about the road surface state, and informs a driver of the determination result, and a method of providing safe driving for the vehicle.

Additional features of the present disclosure will be set forth in part in the description which follows and in part will become apparent to those having ordinary skill in the art upon examination of the following or may be learned from practice of the disclosure.

In accordance with an aspect of the present disclosure, the above can be accomplished by the provision of a vehicle including a wireless communication unit, a vehicle stability system configured to be operated during rapid braking of the vehicle, a sensor unit configured to detect the state of a road surface on which the vehicle is traveling, and a controller configured to, during operation of the ABS unit, detect the state of the road surface through the sensor unit, generate information about the detected state of the road surface, transmit the generated information about the state of the road surface to at least one external object via the wireless communication unit, and share the information with the at least one external object.

During operation of the vehicle stability system, the controller may predict a coefficient of friction of the road surface using acceleration in the longitudinal direction of the vehicle and acceleration in the lateral direction of the vehicle, sensed through the sensor unit, and may generate the information about the state of the road surface including a degree of danger indicating whether the state of the road surface corresponds to a dangerous state or a safe state based on the predicted coefficient of friction.

The vehicle may further include a location acquisition unit configured to acquire the location of a road on which the vehicle is travelling. During operation of the vehicle stability system, the controller may acquire the location of the road through the location acquisition unit, and may generate the information about the state of the road surface including the degree of danger and the acquired location of the road.

The vehicle may further include a navigation unit configured to guide a travel route to a destination. During operation of the vehicle stability system, the controller may sense a moving direction of the vehicle based on a map through the navigation unit, and may generate the information about the state of the road surface including the degree of danger, the acquired location of the road and the sensed moving direction of the vehicle.

When at least one predetermined external vehicle is present within a predetermined distance, the controller may transmit the information about the state of the road surface to the at least one external vehicle and may share the information with the at least one external vehicle. When the at least one predetermined external vehicle is not present within the predetermined distance, the controller may transmit the information about the state of the road surface to an external server configured to provide the information about the state of the road surface to the at least one predetermined external vehicle.

In accordance with another aspect of the present disclosure, there is provided a method of providing information about a road surface state for a vehicle, the method including, when a vehicle stability system function of the vehicle is operated, detecting the state of a road surface on which the vehicle is traveling, generating information about the detected state of the road surface, and transmitting the generated information about the state of the road surface to at least one external object and sharing the information with the at least one external object.

In accordance with a further aspect of the present disclosure, there is provided a vehicle including a wireless communication unit configured to receive information about the state of a road surface on which at least one external vehicle is traveling from the at least one external vehicle, and a controller configured to determine whether the state of a road surface on which the vehicle is currently traveling corresponds to a dangerous state or a safe state based on the received information about the state of the road surface, activate one mode of a danger mode and a safety mode in response to the determination result, and inform a driver of the activated mode.

When the moving direction of the external vehicle, included in the received information about the state of the road surface, is consistent with the direction in which the vehicle is currently traveling, the controller may determine whether the state of the road surface on which the vehicle is currently traveling corresponds to a dangerous state or a safe state based on a degree of danger included in the information about the state of the road surface.

When the danger mode is activated in response to the determination result, the controller may perform control such that, before the vehicle currently traveling approaches within a predetermined distance from the location of a road, included in the information about the state of the road surface, the vehicle generates a warning sound and an increased or maximum speed of the vehicle does not exceed a predetermined speed.

In accordance with a still further aspect of the present disclosure, there is provided a method of providing safe driving for a vehicle, the method including receiving information about the state of a road surface on which at least one external vehicle is traveling from the at least one external vehicle, determining whether the state of a road surface on which the vehicle is currently traveling corresponds to a dangerous state or a safe state based on the received information about the state of the road surface, activating one mode of a danger mode and a safety mode in response to the determination result, and informing a driver of the activated mode.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing the construction of a first vehicle according to the present disclosure, which provides information about the state of the road surface on which the first vehicle is traveling;

FIG. 2 is a flowchart showing a process of providing information about the state of the road surface on which the first vehicle according to the present disclosure is traveling;

FIG. 3 is a graph showing the correlation between a slip ratio and a braking force coefficient depending on the road surface state during rapid braking;

FIG. 4 is a block diagram showing the construction of a second vehicle according to the present disclosure, which provides safe driving using the information about the road surface state received from the first vehicle;

FIG. 5 is a flowchart showing a process of providing, by the second vehicle, safe driving using the information about the road surface state received from the first vehicle according to the present disclosure; and

FIG. 6 is a view showing communication system environments between a vehicle and another vehicle and between a vehicle and an external server.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The suffixes “module” and “unit” of elements herein are used for convenience of description and thus can be used interchangeably and do not have any distinguishable meanings or functions. In addition, in the following description, a detailed description of related known technologies may be omitted when it may obscure the subject matter of the present disclosure. In addition, the accompanying drawings have been made only for a better understanding and are not intended to limit technical ideas disclosed herein, and it should be understood that the accompanying drawings are intended to encompass all modifications, equivalents and substitutions included in the spirit and scope of the present disclosure.

While ordinal numbers including “first”, “second”, etc. may be used to describe various components, they are not intended to limit the components. These expressions may be used to distinguish one component from another component.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The singular forms are intended to include the plural forms as well, unless the context clearly indicates otherwise.

In the specification, the terms “comprising”, “including”, and “having” shall be understood to designate the presence of particular features, numbers, steps, operations, elements, parts, or combinations thereof but not to preclude the presence or addition of one or more other features, numbers, steps, operations, elements, parts, or combinations thereof.

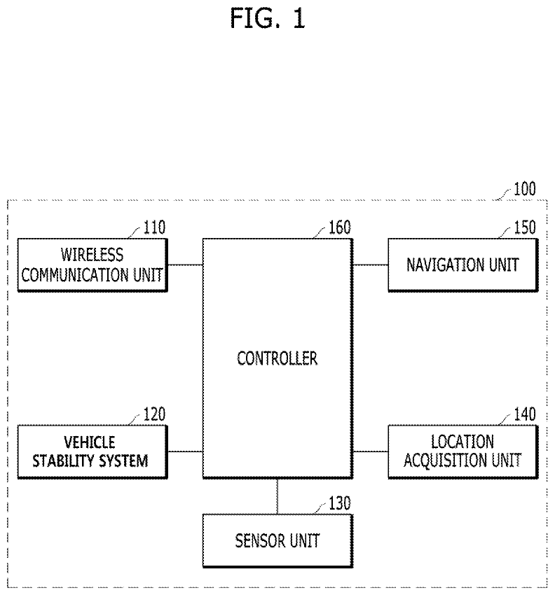

FIG. 1 is a block diagram showing the construction of a first vehicle according to the present disclosure, which provides information about the state of the road surface on which the first vehicle is traveling.

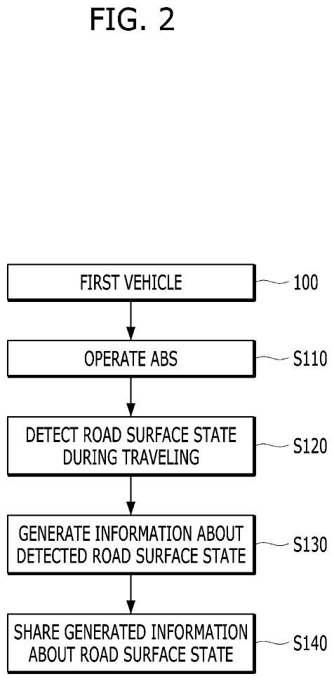

FIG. 2 is a flowchart showing a process of providing information about the state of the road surface on which the first vehicle according to the present disclosure is traveling.

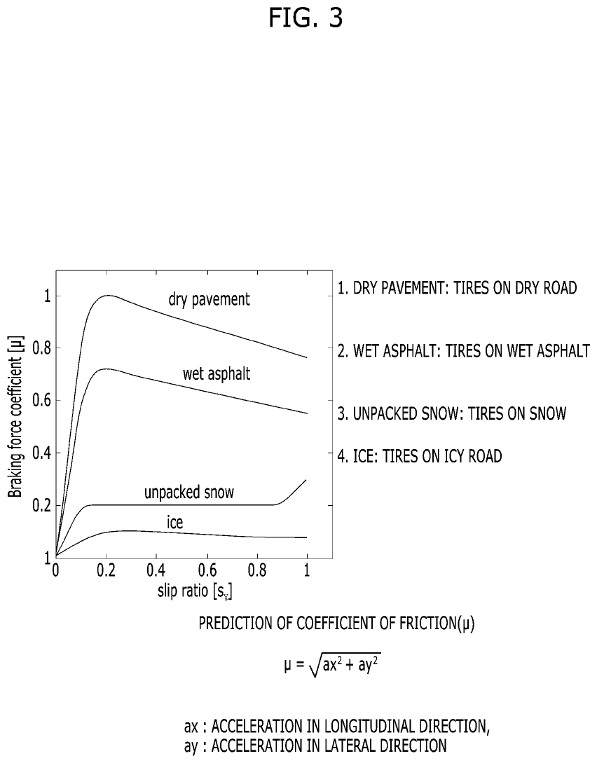

FIG. 3 is a graph showing the correlation between a slip ratio and a braking force coefficient depending on the road surface state during rapid braking.

Referring to FIGS. 1 to 3, the first vehicle 100 according to the present disclosure, which transmits information about the state of the road surface on which the first vehicle 100 is traveling to a second vehicle and/or an external server 300 and shares the information therewith, includes a wireless communication unit 110, a vehicle stability system 120, a sensor unit 130, a location acquisition unit 140, a navigation unit 150, and a controller 160.

The wireless communication unit 110 may provide wireless communication with the second vehicle 200 and/or wireless communication with the external server 300, and may include at least one of a mobile communication module, a wireless Internet module, or a short-range communication module.

The mobile communication module may transmit or receive wireless signals to or from the second vehicle 200 and/or the external server 300, which may correspond to a base station, over a mobile communication network, which is constructed according to technical standards or communication methods for mobile communication (e.g. Global System for Mobile communication (GSM), Code Division Multi-Access (CDMA), Wideband CDMA (WCDMA), High Speed Downlink Packet Access (HSDPA), Long Term Evolution (LTE), and the like).

The wireless Internet module is a module for facilitating wireless Internet access. The wireless Internet module may be internally or externally installed in the first vehicle 100, and may transmit or receive wireless signals to or from the second vehicle 200 and/or the external server 300 over a communication network according to wireless Internet technologies.

Examples of wireless Internet technologies include Wireless LAN (WLAN), Wireless Fidelity (Wi-Fi) Direct, Digital Living Network Alliance (DLNA), Wireless Broadband (WiBro), Worldwide Interoperability for Microwave Access (WiMAX), High Speed Downlink Packet Access (HSDPA), Long Term Evolution (LTE), and the like. The wireless Internet module may transmit or receive data according to at least one of the above wireless Internet technologies, and other Internet technologies as well.

When the wireless Internet access is implemented according to, for example, WiBro, HSDPA, GSM, CDMA, WCDMA, LTE, and the like, as part of a mobile communication network, the wireless Internet module performs such wireless Internet access. As such, the wireless Internet module may cooperate with, or function as, the mobile communication module.

The short-range communication module serves to perform short-range communication. The short-range communication module may support short-range communication using at least one technology of Bluetooth™, Radio Frequency IDentification (RFID), Infrared Data Association (IrDA), Ultra-WideBand (UWB), ZigBee, Near Field Communication (NFC), Wireless-Fidelity (Wi-Fi), or Wi-Fi Direct. The short-range communication module enables short-range communication between the first vehicle 100 and the second vehicle 200 or between the first vehicle 100 and the external server 300 over wireless personal area networks.

The vehicle stability system 120 operates during rapid braking. The vehicle stability system 120 may include an anti-lock brake system (ABS) and Electronic Brake System (EBS). Here, the ABS may include ABS module and wheel sensor, and the ABS function is implemented by inhibiting or preventing wheels from being locked. The EBS system may include EBS module, wheel sensor, yaw sensor, steering angle sensor, etc. The EBS may be the upper version of the ABS and has anti-lock braking function as well as many functions such as vehicle stability control, engine torque control and yaw control. The controller for the vehicle stability system 120 may include a hydraulic electrical control unit (HECU) and air pressure control valve (PCV) unit.

The vehicle stability system 120 calculates the difference between the speed of the first vehicle 100 and the speed of the wheels of the first vehicle 100, and inhibits the wheels of the first vehicle 100 from being locked up in order to obtain increased static friction force.

The sensor unit 130 may sense the acceleration in the longitudinal direction and the acceleration in the lateral direction of the first vehicle 100 in order to detect the state of the road surface on which the first vehicle 100 is traveling.

The location acquisition unit 140 may acquire the current location of the first vehicle 100, and a representative example thereof includes a Global Positioning System (GPS) module. For example, the first vehicle 100 may acquire the current location of the first vehicle 100 using a signal received from a GPS satellite upon utilizing the GPS module.

The navigation unit 150 may visually/acoustically output information related to the first vehicle 100, may output a map on a screen, and may display information related to the area in which the first vehicle 100 is traveling and the travel route to the destination set by a user on the map.

The navigation unit 150 may include a display unit and a sound output unit.

The display unit may be implemented as a touchscreen, and may be configured to display information related to the first vehicle 100 and information related to various multimedia and navigational content. The sound output unit may be configured to output voice/sound effects corresponding to the information related to the first vehicle 100, voice/sound effects/warning sounds related to various multimedia and navigational content, and warning sounds related to the driving conditions of the first vehicle 100.

The controller 160 may be configured to control the overall operation of the first vehicle 100 according to the present disclosure. Hereinafter, a process of providing information about the state of the road surface on which the first vehicle 100 according to the present disclosure is traveling will be described in detail with reference to FIGS. 2 and 3.

Referring to FIGS. 2 and 3, when the controller 160 of the first vehicle 100 determines that the ABS unit 120 is activated by rapid braking while the first vehicle 100 is traveling on the road (S110), the controller 160 detects the road surface state at the time point at which the vehicle stability system 120 is activated through the sensor unit 130 (S120) and generates information about the detected road surface state (S130).

In detail, the controller 160 detects the acceleration in the longitudinal direction and the acceleration in the lateral direction of the first vehicle 100 at the time point at which the vehicle stability system 120 is activated through the sensor unit 130, and predicts the coefficient of friction of the road surface using the detected acceleration in the longitudinal direction of the first vehicle 100 and the detected acceleration in the lateral direction thereof.

Referring to FIG. 3, the vehicle travels using grip force between the tires thereof and the ground. The more slippery the road surface, the smaller the coefficient of friction. The degree of slippage between the tires and the road surface is referred to as a slip ratio.

The graph in FIG. 3 shows the correlation between the slip ratio and the braking force coefficient depending on the road surface state when the vehicle is braked while traveling straight.

In FIG. 3, “dry pavement” represents the correlation between the slip ratio and the braking force coefficient of the tires on a dry road, “wet asphalt” represents the correlation between the slip ratio and the braking force coefficient of the tires on a wet asphalt road, “unpacked snow” represents the correlation between the slip ratio and the braking force coefficient of the tires on a snowy road, and “ice” represents the correlation between the slip ratio and the braking force coefficient of the tires on an icy road.

The controller 160 may predict the braking force coefficient using Equation 3 as shown in FIG. 3, and may determine the degree of danger, which indicates whether the road surface state corresponds to a dangerous state or a safe state, based on the predicted braking force coefficient.

For example, on the basis of the regulations on emergency braking signal operation criteria, when the deceleration of cars, trucks and special vehicles, which have a total weight of 3.5 tons or less, is 0.6 g during rapid braking, it may be determined that the degree of danger is a “danger” state, i.e. that the road surface state corresponds to a dangerous state. In addition, when the deceleration of vans, trucks and special vehicles, which have a total weight greater than 3.5 tons, is 0.4 g or greater during rapid braking, it may be determined that the degree of danger is a “danger” state, i.e. that the road surface state corresponds to a dangerous state.

In addition, the degree of danger may be determined based on the predicted braking force coefficient.

For example, when the predicted braking force coefficient is 0.3 or less, it may be determined that the road surface is slippery and that the degree of danger is a “danger” state.

In another example, when the predicted braking force coefficient ranges from 0.3 to 0.7, it may be determined that the road surface is moderately slippery and that the degree of danger is a “danger” state.

In still another example, when the predicted braking force coefficient is 0.7 or greater, it may be determined that the road surface is dry and that the degree of danger is a “safety” state.

Upon determining the degree of danger based on at least one of the deceleration of the vehicle or the braking force coefficient, the controller 160 may acquire the location of the road on which the first vehicle 100 is located at the time point at which the GPS unit 120 is activated through the location acquisition unit 140, and may generate information about the road surface state including the degree of danger and the location of the road.

In addition, upon determining the degree of danger based on at least one of the deceleration of the vehicle or the braking force coefficient, the controller 160 may sense the direction in which the first vehicle 100 moves based on the map through the navigation unit 150, and may generate information about the road surface state including the degree of danger, the location of the road and the sensed moving direction of the vehicle.

Subsequently, the controller 160 may transmit the generated information about the road surface state to at least one external object via the wireless communication unit 110 and may share the information therewith (S140).

At this time, the at least one external object may be the second vehicle 200 and/or the external server 300.

In addition, when the second vehicle 200 is present within a predetermined distance, the controller 160 may directly transmit the information about the road surface state to the second vehicle 200 via the wireless communication unit 110, and may share the information therewith. When the second vehicle 200 is not present within the predetermined distance, the controller 160 may transmit the information about the road surface state to the external server 300, and the external server 300 may transmit the information about the road surface state to the second vehicle 200.

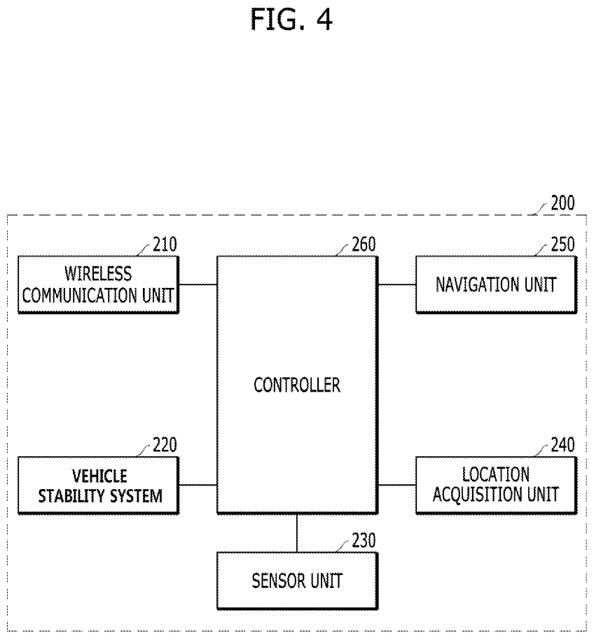

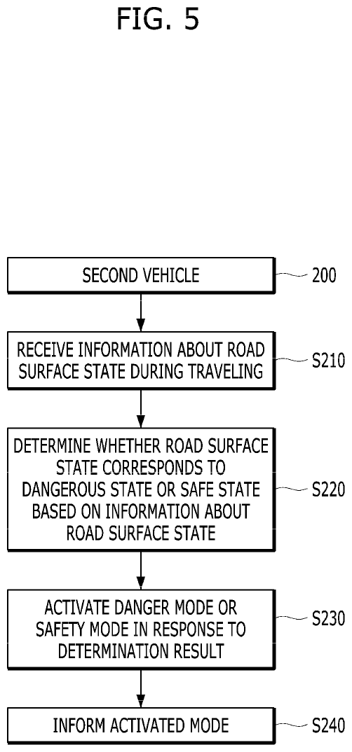

Hereinafter, a process of providing, by the second vehicle 200, safe driving will be described in detail with reference to FIGS. 4 and 5.

FIG. 4 is a block diagram showing the construction of the second vehicle according to the present disclosure, which provides safe driving using the information about the road surface state received from the first vehicle.

FIG. 5 is a flowchart showing a process of providing, by the second vehicle, safe driving using the information about the road surface state received from the first vehicle according to the present disclosure.

Referring to FIGS. 4 and 5, the second vehicle 200 according to the present disclosure, which provides safe driving to a driver using the information about the road surface state generated in the first vehicle 100, received from the first vehicle 100 or the external server 300, includes a wireless communication unit 210, a vehicle stability system unit 220, a sensor unit 230, a location acquisition unit 240, a navigation unit 250, and a controller 260.

Since the operation of the wireless communication unit 210, the vehicle stability system 220, the sensor unit 230, the location acquisition unit 240, the navigation unit 250 and the controller 260 of the second vehicle 200 is substantially the same as that of the wireless communication unit 110, the vehicle stability system 120, the sensor unit 130, the location acquisition unit 140, the navigation unit 150 and the controller 160 of the first vehicle 100, a detailed description thereof will be omitted.

Upon directly receiving the information about the road surface state generated in the first vehicle 100 from the first vehicle 100 via the wireless communication unit 210 or upon receiving the information about the road surface state generated in the first vehicle 100 via the external server 300 (S210), the controller 260 determines whether the state of the road surface on which the second vehicle 200 is traveling corresponds to a dangerous state or a safe state based on the received information about the road surface state (S220), activates one mode of a danger mode and a safety mode in response to the determination result (S230), and informs the driver of the second vehicle 200 of the activated mode (S240).

In detail, when the moving direction of the first vehicle 100, which is included in the received information about the road surface state, is consistent with the direction in which the second vehicle 200 is currently traveling, the controller 260 may determine whether the state of the road surface on which the second vehicle 200 is traveling corresponds to a dangerous state or a safe state based on the degree of danger included in the received information about the road surface state.

Upon determining that the degree of danger included in the received information about the road surface state is a “danger” state, the controller 260 activates the danger mode. Upon determining that the degree of danger included in the received information about the road surface state is a “safety” state, the controller 260 activates the safety mode.

In addition, when the moving direction of the first vehicle 100, which is included in the received information about the road surface state, is consistent with the direction in which the second vehicle 200 is currently traveling and when the road on which the first vehicle 100 is located, which is included in the received information about the road surface state, is the same as the road on which the second vehicle 200 is currently traveling, the controller 260 may determine whether the state of the road surface on which the second vehicle 200 is currently traveling corresponds to a dangerous state or a safe state based on the degree of danger included in the received information about the road surface state.

In the state in which the danger mode is activated, the controller 260 may perform control such that, before the second vehicle 200 approaches within a predetermined distance (e.g. 500 m) from the location of the road, which is included in the information about the road surface state, the second vehicle generates a warning sound and turns on a warning light, the maximum speed of the second vehicle does not exceed a predetermined speed, and a pressure of 1 to 3 bar is applied to the brake of the second vehicle in order to rapidly obtain braking force.

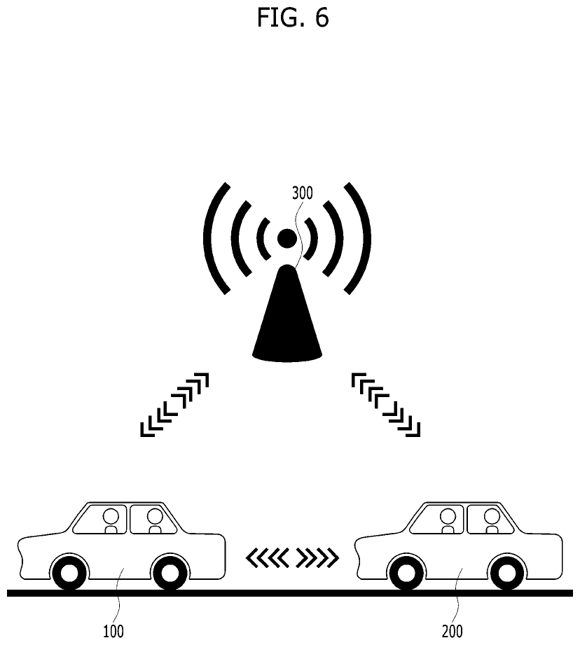

Referring to FIG. 6, the first vehicle 100 may transmit the information about the road surface state to the second vehicle 200 and the external server 300.

The external server 300 may be a base station, which may serve as a traffic information provision center that provides detailed information about the road surface state of every road. When receiving the information about the road surface state from the first vehicle 100, the external server 300 recognizes the location of the road, which is included in the received information about the road surface state, and the road surface state corresponding to the moving direction of the first vehicle 100 from the road surface state information database. When the degree of danger corresponding to the recognized road surface state is different from the degree of danger included in the received information about the road surface state, the external server 300 may correct the degree of danger included in the received information about the road surface state so that the degree of danger included in the received information about the road surface state becomes consistent with the degree of danger corresponding to the recognized road surface state, and may transmit the corrected degree of danger to the second vehicle 200.

The second vehicle 200 receives the information about the road surface state (hereinafter referred to as “first road surface state information”) from the first vehicle 100, and also receives the information about the road surface state (hereinafter referred to as “second road surface state information”) from the external server 300.

When both the degree of danger included in the first road surface state information and the degree of danger included in the second road surface state information are “danger” states, the second vehicle 200 activates a first danger mode. If the first danger mode is activated, the second vehicle 200 is controlled such that, before the second vehicle 200 approaches within a predetermined distance (e.g. 500 m) from the location of the road, which is included in the information about the road surface state, the second vehicle generates a warning sound and turns on a warning light, the maximum speed of the second vehicle does not exceed a predetermined speed, and a pressure of 1 to 3 bar is applied to the brake of the second vehicle in order to rapidly obtain braking force.

When the degree of danger included in the first road surface state information is a “danger” state and the degree of danger included in the second road surface state information is a “safety” state, the second vehicle 200 activates a second danger mode. If the second danger mode is activated, the second vehicle 200 is controlled such that, before the second vehicle 200 approaches within a predetermined distance (e.g. 500 m) from the location of the road, which is included in the information about the road surface state, the second vehicle generates a warning sound and turns on a warning light, the maximum speed of the second vehicle does not exceed a predetermined speed, and the second vehicle outputs information instructing the driver to drive the second vehicle to a lane avoidance road or searches for a detour and provides the found detour to the driver through the navigation unit 250.

When the degree of danger included in the first road surface state information is a “safety” state and the degree of danger included in the second road surface state information is a “danger” state, the second vehicle 200 activates a partial safety mode. If the partial safety mode is activated, the second vehicle 200 is controlled such that, before the second vehicle 200 approaches within a predetermined distance (e.g. 500 m) from the location of the road, which is included in the information about the road surface state, the second vehicle generates a warning sound, and a pressure of 1 to 3 bar is applied to the brake of the second vehicle in order to rapidly obtain braking force.

When both the degree of danger included in the first road surface state information and the degree of danger included in the second road surface state information are “safety” states, the second vehicle 200 does not perform any control operation.

As is apparent from the above description, according to one aspect of the present disclosure, vehicles share information about a road surface state with each other, particularly when the road surface state is poor, e.g. when rapid braking is performed, thereby providing a safer driving environment to a driver.

The terminologies used in the present disclosure are defined in consideration of their functions in the present disclosure. Since the terminologies may be modified depending on the intention or practice of a person skilled in the art, the terminologies should be defined on the basis of the detailed meanings which are described in relevant parts of the description herein.

The scope of the disclosure should be determined by reasonable interpretation of the appended claims, and all changes that fall within the equivalent scope of the disclosure are included in the scope of the disclosure.

The present disclosure is not limited to the above, but rather those skilled in the art will appreciate that various modifications, additions and substitutions are possible, without departing from the scope and spirit of the disclosure.

What is claimed is:

1. A vehicle comprising:
a wireless communication unit;
a vehicle stability system configured to be operated during rapid braking of the vehicle;
a sensor unit configured to detect a state of a road surface on which the vehicle is traveling; and
a controller configured to, during operation of the vehicle stability system, detect the state of the road surface through the sensor unit, generate information about the detected state of the road surface, transmit the generated information about the state of the road surface to at least one external object via the wireless communication unit, and share the information with the at least one external object.

2. The vehicle according to claim 1, wherein, during operation of the vehicle stability system, the controller is configured to predict a coefficient of friction of the road surface using acceleration in a longitudinal direction of the vehicle and acceleration in a lateral direction of the vehicle, sensed through the sensor unit, and to generate the information about the state of the road surface comprising a degree of danger indicating whether the state of the road surface corresponds to a dangerous state or a safe state based on the predicted coefficient of friction.

3. The vehicle according to claim 2, further comprising:
a location acquisition unit configured to acquire a location of a road on which the vehicle is travelling,
wherein, during operation of the vehicle stability system, the controller is configured to acquire the location of the road through the location acquisition unit, and to generate the information about the state of the road surface comprising the degree of danger and the acquired location of the road.

4. The vehicle according to claim 3, further comprising:
a navigation unit configured to guide a travel route to a destination,
wherein, during operation of the vehicle stability system, the controller is configured to sense a moving direction of the vehicle based on a map through the navigation unit, and to generate the information about the state of the road surface comprising the degree of danger, the acquired location of the road and the sensed moving direction of the vehicle.

5. The vehicle according to claim 1, wherein, when at least one external vehicle is present within a predetermined distance, the controller is configured to transmit the information about the state of the road surface to the at least one external vehicle and to share the information with the at least one external vehicle, and
wherein, when the at least one predetermined external vehicle is not present within the predetermined distance, the controller is configured to transmit the information about the state of the road surface to an external server configured to provide the information about the state of the road surface to the at least one predetermined external vehicle.

6. A method of providing information about a road surface state for a vehicle, the method comprising: when an anti-lock braking function of the vehicle is operated,
detecting a state of a road surface on which the vehicle is traveling;
generating information about the detected state of the road surface; and
transmitting the generated information about the state of the road surface to at least one external object and sharing the information with the at least one external object.

7. The method according to claim 6, wherein the detecting comprises sensing acceleration in a longitudinal direction of the vehicle and acceleration in a lateral direction of the vehicle, and
wherein the generating comprises, during operation of the anti-lock braking function, predicting a coefficient of friction of the road surface using the sensed acceleration in the longitudinal direction of the vehicle and the sensed acceleration in the lateral direction of the vehicle, and generating the information about the state of the road surface comprising a degree of danger indicating whether the state of the road surface corresponds to a dangerous state or a safe state based on the predicted coefficient of friction.

8. The method according to claim 7, wherein the generating comprises, during operation of the anti-lock braking function, acquiring a location of a road on which the vehicle is travelling, and generating the information about the state of the road surface comprising the degree of danger and the acquired location of the road.

9. The method according to claim 8, wherein the generating comprises, during operation of the anti-lock braking function, sensing a moving direction of the vehicle based on a map, and generating the information about the state of the road surface comprising the degree of danger, the acquired location of the road and the sensed moving direction of the vehicle.

10. The method according to claim 6, wherein, when at least one predetermined external vehicle is present within a predetermined distance, the sharing comprises transmitting the information about the state of the road surface to the at least one external vehicle, and sharing the information with the at least one external vehicle, and
wherein, when the at least one predetermined external vehicle is not present within the predetermined distance, the sharing comprises transmitting the information about the state of the road surface to an external server configured to provide the information about the state of the road surface to the at least one predetermined external vehicle.

11. A vehicle comprising:
a wireless communication unit configured to receive information about a state of a road surface on which at least one external vehicle is traveling from the at least one external vehicle; and
a controller configured to determine whether a state of a road surface on which the vehicle is currently traveling corresponds to a dangerous state or a safe state based on the received information about the state of the road surface, activate one mode of a danger mode and a safety mode in response to a determination result, and inform a driver of the activated mode.

12. The vehicle according to claim 11, wherein, when a moving direction of the external vehicle, included in the received information about the state of the road surface, is consistent with a direction in which the vehicle is currently traveling, the controller determines whether the state of the road surface on which the vehicle is currently traveling corresponds to a dangerous state or a safe state based on a degree of danger included in the information about the state of the road surface.

13. The vehicle according to claim 11, wherein, when the danger mode is activated in response to the determination result, the controller performs control such that, before the vehicle currently traveling approaches within a predetermined distance from a location of a road, included in the information about the state of the road surface, the vehicle generates a warning sound and a maximum speed of the vehicle does not exceed a predetermined speed.

14. A method of providing safe driving for a vehicle, the method comprising:
receiving, by a wireless communication unit, information about a state of a road surface on which at least one external vehicle is traveling from the at least one external vehicle;
determining, by a controller, whether a state of a road surface on which the vehicle is currently traveling corresponds to a dangerous state or a safe state based on the received information about the state of the road surface;
activating, by the controller, one mode of a danger mode and a safety mode in response to a determination result; and
informing a driver of the activated mode by a visual or audio signal.

15. The method according to claim 14, wherein, when a moving direction of the external vehicle, included in the received information about the state of the road surface, is consistent with a direction in which the vehicle is currently traveling, the determining comprises determining whether the state of the road surface on which the vehicle is currently traveling corresponds to a dangerous state or a safe state based on a degree of danger included in the information about the state of the road surface.

16. The method according to claim 14, wherein, when the danger mode is activated in response to the determination result, the informing comprises performing control such that, before the vehicle currently traveling approaches within a predetermined distance from a location of a road, included in the information about the state of the road surface, the vehicle generates a warning sound and a maximum speed of the vehicle does not exceed a predetermined speed.
